(19) United States
(12) Patent Application Publication
(10) Pub. No.: US 2026/0184542 A1
(43) Pub. Date: Jul. 2, 2026

(54) Control of Flippers of a Spreader Configured to Lift a Container

(71) Applicant: ABB Schweiz AG, Baden (CH)

(72) Inventors: Mario Harkmaa, Västerås (SE); Jonas Öhr, Torsåker (SE); Olof Edström, Västerås (SE)

(73) Assignee: ABB Schweiz AG, Baden (CH)

(21) Appl. No.: 19/432,403

(22) Filed: Dec. 24, 2025

(30) Foreign Application Priority Data
Dec. 30, 2024 (EP) 24223645.3

(51) Int. Cl. B66C 1/66; B65G 63/00

(52) U.S. Cl. CPC B66C 1/663; B65G 63/004

(57) ABSTRACT

A computer implemented method for controlling at least one flipper of a spreader configured to lift a container includes controlling the at least one flipper arm to move from a down position towards an up position, waiting for a predetermined time duration, and after the predetermined time duration has lapsed, controlling the at least one flipper arm to move to the down position.

### CROSS-REFERENCE TO RELATED APPLICATIONS

The instant application claims priority to European Patent Application No. 24223645.3, filed Dec. 30, 2024, which is incorporated herein in its entirety by reference.

### FIELD OF THE DISCLOSURE

The present disclosure generally relates to a computer implemented method for controlling at least one flipper of a spreader configured to lift a container, to a control unit, to a spreader, and to a computer program product.

### BACKGROUND OF THE INVENTION

A container spreader is used for lifting containers at their four corners. To assist in a lifting operation of a container, flipper arms of the spreaders assist in aligning the lifting mechanism of the spreader to the lifting points on the containers.

Traditional spreaders use flippers that either remain in a fixed down position during pickup or can stop at intermediate positions to catch containers. The former approach limits operational flexibility, while the latter requires specialized flippers capable of intermediate stops, increasing complexity and costs.

### BRIEF SUMMARY OF THE INVENTION

The present disclosure generally describes a method and spreader that at least partly alleviates the drawbacks of prior art. According to a first aspect of the disclosure, there is provided a computer implemented method for controlling at least one flipper of a spreader configured to lift a container, the method comprising: controlling the at least one flipper arm to move from a down position towards an up position, waiting for a predetermined time duration, and after the predetermined time duration has lapsed, controlling the at least one flipper arm to move to the down position.

Embodiments in accordance with the present disclosure are is at least partly based on the realization that, when approaching a container, first give an up order followed by a brief waiting period during which time duration the flipper arm moves up, and subsequently give a down order. This provides for the flipper arm to “open” slightly to allow for better alignment with the container, followed by a closing of the flipper arm for final alignment.

A spreader is a lifting device commonly used in port and terminal operations for handling intermodal containers. The spreader is typically attached to a crane and is designed to adjust its width to fit various container sizes, ensuring a secure and balanced lift. Equipped with twist locks or other securing mechanisms at each corner, the spreader engages with the container's corner castings, allowing it to lift, move, and place containers efficiently.

A flipper arm is a component of a spreader that assists in positioning the spreader on the container for securing lifting and handling operations. Flipper arms are mounted on the sides of the spreader and can move between up and down positions. In the up position, the flipper arms facilitate the spreader's alignment with the container, while in the down position, they help secure the container by engaging with its sides. For example, the flipper arm contacts the container and guides the spreader so as to align a lock engagement between the spreader and container.

### BRIEF DESCRIPTION OF THE SEVERAL VIEWS OF THE DRAWING(S)

FIG. 1 is a diagram of a crane hoisting a spreader according to an embodiment of the present disclosure.

FIG. 2 is a diagram of a series of positions during control of flippers of a spreader according to according to an embodiment of the present disclosure.

FIG. 3 is a flowchart for a method in accordance with the present disclosure.

FIG. 4 is a flowchart for a method in accordance with the present disclosure.

FIG. 5 is a flowchart for a method in accordance with the present disclosure.

### DETAILED DESCRIPTION OF THE INVENTION

In the present detailed description, various embodiments of the present invention are herein described with reference to specific implementations. In describing embodiments, specific terminology is employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without parting from the scope of the invention.

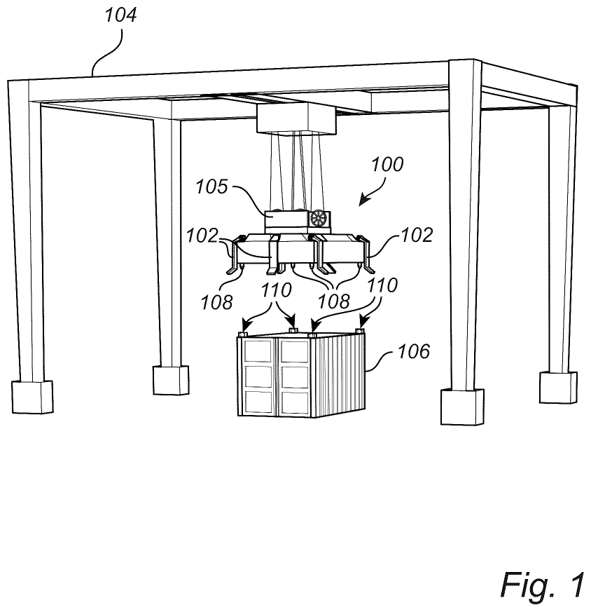

FIG. 1 schematically illustrates a spreader 100 having multiple flipper arms 102. The spreader 100 is attached to a crane 104 via a hoisting mechanism 105 which is configured to lift the spreader up and down for lifting the container 106. The spreader 100 can adjust its width to accommodate for different sized containers.

The spreader 100 includes twist locks 108 which are adapted to lock into corresponding receiving units 110 of the container, often in the form of receiver holes 110. The geometry of the twist locks ensures engagement in the receiving holes 110 once rotated while maintaining inserted in place in the receiving holes 110.

The flippers 102, equally termed flipper arms 102, are mounted on the sides of the spreader 100 and can move between up and down positions. In the up position, the flipper arms 102 facilitate the spreader's 100 alignment with the container 100, while in the down position, they help secure the container 106 by engaging with its sides. In FIG. 1, the flipper arms are in their down position as the crane 104 is lowering the spreader 100 towards the container 106. The crane 104 and the spreader 100 may be operated by a crane operator.

Although the number of flipper arms 102 varies depending on the spreader type, in this example the spreader 100 has at least four, in this case six flippers that are controlled according to embodiments of the present disclosure.

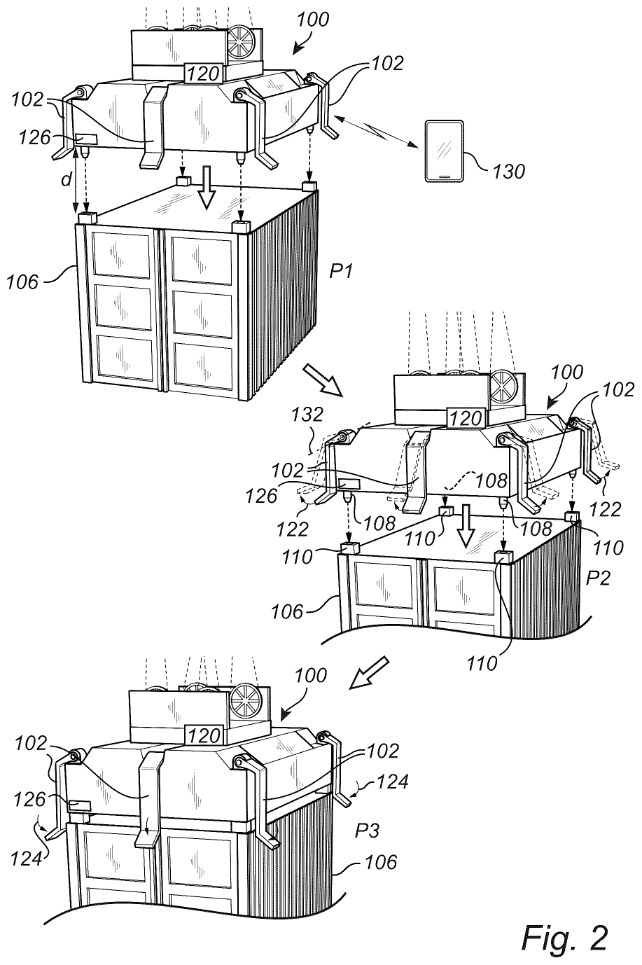

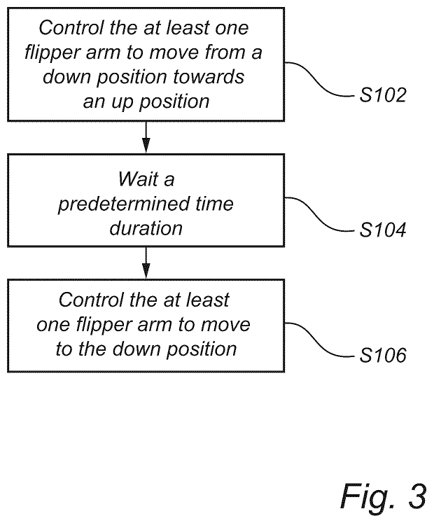

Turning to FIG. 2 in conjunction with the flowchart of FIG. 3, in the position P1 of the spreader 100 in FIG. 2, the flippers 102 are in their down position. The spreader 100 is moving downwards towards the container 106. A control unit 120 is configured to, in step S102, control the at least one flipper arm 102 to move from a down position towards an up position. As shown in position P2 where the spreader 100 is closer to the container compared to position P1, the flipper arms are now moving towards the up position. That is, they are “opening” to facilitate positioning of the container 106.

Once triggering the motion of the flipper arms 102, the control unit 120 waits, in step S104, for a predetermined time duration so that the flipper arms 102 are allowed to move, as indicated by arrows 122, slightly towards the up position, although not to the full up position.

Once the predetermined time duration has lapsed, the control unit 120 controls the at least one flipper arm 102 to move to the down position as indicated in position P3 where the flipper arms 102 has moved in the opposite direction indicated by arrows 124. The motion of the flipper arms 102 is by rotation about a pivot axis at one end of the flipper arms 102. One pivot axis 132 is indicated in FIG. 2 position P2.

The predetermined time duration is sufficiently long for allowing the flipper arms to open slightly for the spreader 100 to receive the container 106, and then to close, i.e., move back to the down position once the container is in place. The predetermined time duration may be fixed and selected in the range of 0.3 seconds to 1.5 seconds. In a preferred embodiment the predetermined time duration is about 0.6 seconds.

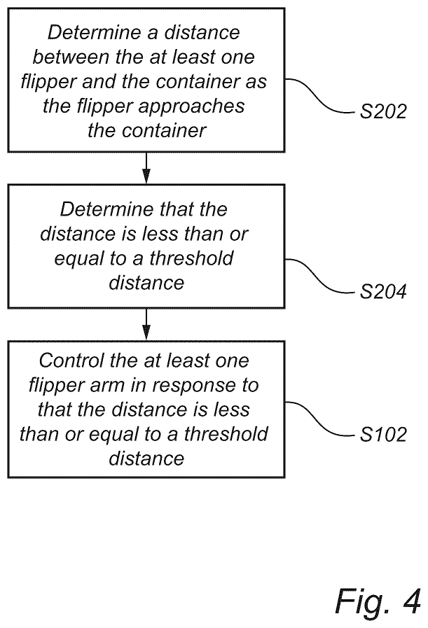

FIG. 4 is a flow-chart of method steps that precedes the steps in FIG. 3. In step S202, determining, by the control unit 120, a distance d between the at least one flipper 102 and the container 106 as the flipper 102 approaches the container 106. The distance, d, between the at least one flipper 102 and the container 106 is measured by a sensor 126 on the spreader 100. The sensor 126 may be for example ultrasonic sensors or laser based, e.g., Lidar.

In step S204, the control unit 120 determines that the distance is less than or equal to a threshold distance. In response to that the distance is less than or equal to a threshold distance, the control unit 120 controls the at least one flipper arm to move towards the up position in step S102 described in relation to FIGS. 2 and 3.

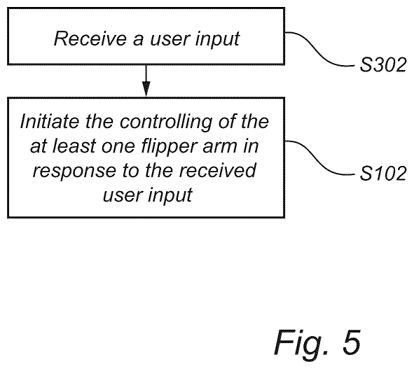

FIG. 5 is a flowchart of method steps of an alternative embodiment, where in step S302, the control unit 120 receives a user input to trigger the movement of the flipper 102. In this embodiment there is no need for sensors 126. Instead, the operator may visually inspect the lowering of the spreader 100 towards the container 106 and at the right time trigger the movement of the flippers 102. In response to the received user input the controlling of the at least one flipper arm in step S102 is initiated as described above in conjunction with step S102. Optionally, an alert is provided on a user interface 130 such as a display or a speaker, that the flipper arm 102 is about to be automatically controlled.

Once the method is initiated, either automatically by detecting that the distance between the at least one flipper and the container is less than or equal to a threshold distance, or by receiver user input, the method steps involving control of the flippers 102 are automated. The control unit 120 may be implemented in an embedded control system such as a programmable logic controller, PLC.

A control unit may include a microprocessor, microcontroller, programmable digital signal processor or another programmable device. The control unit may also, or instead, include an application specific integrated circuit, a programmable gate array or programmable array logic, a programmable logic device, or a digital signal processor. Where the control unit includes a programmable device such as the microprocessor, microcontroller or programmable digital signal processor mentioned above, the processor may further include computer executable code that controls operation of the programmable device.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which correspond to tangible media such as data storage media, or communication media including any media that facilitate the transfer of a computer program from one place to another, e.g., according to a communication protocol. In this manner, computer-readable media generally may correspond to (1) tangible computer-readable storage media which are non-transitory or (2) a communication media such as signal or carrier waves. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer.

In embodiments, the method may comprise determining a distance between the at least one flipper and the container as the flipper approaches the container, determining that the distance is less than or equal to a threshold distance, controlling the at least one flipper arm in response to that the distance is less than or equal to a threshold distance. This advantageously allows for timing the operation of the flipper as the spreader approaches a container.

The distance between the at least one flipper and the container may be measured by a sensor on the spreader. Thus, accurate determination of the distance may be ensured thereby improving the timing of the flipper movement. The accuracy of the sensor is preferably 5 cm or less.

In embodiments, the threshold distance may be based on the speed of the flipper as it approaches the container. By basing the threshold distance on the speed of the flipper, the timing of the flipper movements can be dynamically adjusted. This ensures that the flippers engage with the container at the optimal moment, enhancing the precision of the container capture process.

In embodiments, the method may comprise receiving a user input, and initiating the controlling of the at least one flipper arm in response to the received user input. In other words, the control of the flipper arms may be manually initiated by an operator inspecting the spreader visually, for example using a camera and a display user interface.

In embodiments, the predetermined time duration may be fixed. A fixed predetermined time duration simplifies the control algorithm, ensuring that the flipper arm movements are consistent each time they are triggered. This consistency can lead to predictable and repeatable operations, which are advantageous for maintaining efficiency and reliability in spreaders. The predetermined time duration is sufficiently long for allowing the flipper arms to open for the spreader to receive the container, and then to close to the down position once the container is in place in the spreader.

The predetermined time duration may be selected in the range of 0.3 seconds to 1.5 seconds, preferably about 0.6 seconds.

Preferably, the method steps are automated once initiated. That is, regardless of whether the operation is automated by using sensors, or is manually initiated by user input, the movement of the flipper up and down is automatic.

Preferably, at least four flipper arms of the spreader are controlled.

In embodiments, the method may comprise providing an alert on a user interface that the flipper arm is about to be automatically controlled. That is, an operator may be made aware of the flipper movement before it is triggered.

The method may be implemented in an embedded control system. An embedded control system such as a programmable logic controller, PLC, provides for improved integration with existing systems and control in the spreader.

There is further provided a control unit configured to execute the method of any one of the herein disclosed embodiments.

There is further provided a spreader comprising at least one flipper and a control unit.

There is further provided a computer program product comprising program code for performing the method according to any one of the herein disclosed embodiments, when executed by a control unit.

Further features of, and advantages with, the present invention will become apparent when studying the appended claims and the following description. The skilled person realize that different features of the present invention may be combined to create embodiments other than those described in the following, without departing from the scope of the present invention.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A computer implemented method for controlling at least one flipper of a spreader configured to lift a container, the method comprising:
controlling the at least one flipper arm to move from a down position towards an up position;
waiting for a predetermined time duration; and
after the predetermined time duration has lapsed, controlling the at least one flipper arm to move to the down position.

2. The method according to claim 1, further comprising:
determining a distance between the at least one flipper and the container as the flipper approaches the container,
determining that the distance is less than or equal to a threshold distance; and
controlling the at least one flipper arm in response to that the distance is less than or equal to a threshold distance.

3. The method according to claim 2, wherein the distance between the at least one flipper and the container is measured by a sensor that is disposed on the spreader.

4. The method according to claim 2, wherein the threshold distance is based on a speed of the flipper as it approaches the container.

5. The method according to claim 1, further comprising receiving a user input, and initiating the controlling of the at least one flipper arm in response to the received user input.

6. The method according to claim 1, wherein the predetermined time duration is fixed.

7. The method according to claim 6, wherein the predetermined time duration is sufficiently long for allowing the flipper arms to open, such that the spreader can receive the container, and for closing the flipper arms when the container is in place in the spreader.

8. The method according to claim 1, wherein the predetermined time duration is selected in the range of 0.3 seconds to 1.5 seconds.

9. The method according to claim 1, wherein the method steps are automated once initiated.

10. The method according to claim 1, wherein at least four flipper arms of the spreader are controlled.

11. The method according to claim 1, comprising providing an alert on a user interface that the flipper arm is about to be automatically controlled.

12. The method according to claim 1, wherein the method is implemented in an embedded control system.

13. A control unit configured to execute a method for controlling at least one flipper of a spreader configured to lift a container, the method comprising:
controlling the at least one flipper arm to move from a down position towards an up position;
waiting for a predetermined time duration; and
after the predetermined time duration has lapsed, controlling the at least one flipper arm to move to the down position.

14. A spreader, comprising:
at least one flipper; and
a control unit configured to execute a method for controlling the at least one flipper of a spreader configured to lift a container, the method comprising:
controlling the at least one flipper arm to move from a down position towards an up position;
waiting for a predetermined time duration; and
after the predetermined time duration has lapsed, controlling the at least one flipper arm to move to the down position.
